(19) United States
(12) Patent Application Publication
(10) Pub. No.: US 2010/0036794 A1
(43) Pub. Date: Feb. 11, 2010

(54) CASE GENERATION APPARATUS AND CASE GENERATION METHOD

(75) Inventors: Yoshinori Yaginuma, Kawasaki (JP); Kazuho Maeda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/579,152

(22) Filed: Oct. 14, 2009

Related U.S. Application Data
(63) Continuation of application No. PCT/JP2007/059942, filed on May 15, 2007.

(51) Int. Cl. G06N 5/02; G06F 17/50

(52) U.S. Cl. 706/52; 706/54

(57) ABSTRACT

A computer-readable recording medium stores a case generation program that allows a computer to execute a process of generating a case having one or more design variable values and one or more object variable values corresponding to the design variable values, the process including: acquiring, from a storage section, a plurality of past cases which are obtained through a past evaluation process; predicting the object variable value of the past cases from the design variable values of the acquired past cases; calculating a prediction error and confidence as the prediction result of the past cases; selecting a reference case being a past case used as a reference of the generation based on the calculated prediction error and the confidence; determining a new design variable value based on the design variable value of the selected reference case; and determining a new case based on the new design variable value.

### CROSS-REFERENCE TO RELATED APPLICATIONS

This application is a continuation application, filed under 35 U.S.C. §111(a), of PCT Application No. PCT/JP2007/059942, filed on May 15, 2007, the disclosure of which is herein incorporated in its entirety by reference.

### FIELD

The embodiment discussed herein is related to a case generation apparatus and a case generation method that generate a case for evaluation.

### BACKGROUND

In the manufacturing industry, in addition to a conventional real machine test that has conventionally been conducted, verification (e.g., fluid analysis, electromagnetic wave analysis, and the like) of performance of a product or a part using computer simulation has become very popular recently. In particular the computer simulation can verify performance of an end product in design stage in which the trial model of this product has not been manufactured and give feedback of the verification to the design thereof and, thus, the importance of the computer simulation has been increased.

Further, there may be a case where a cost of a trial product is very expensive in the real machine test or a case where long processing time is required even when a High Performance Computer such as a supercomputer is used in the computer simulation. Thus, an increase in the efficiency of such real machine test or computer simulation is required. Hereinafter, the real machine test and computer simulation are collectively referred to as “evaluation”. Further, a combination of a set of design variable values to be evaluated and an object variable obtained by the evaluation of the design variable value set is referred to as a case.

As a method for improving efficiency of the evaluation, there is available a method that applies filtering to candidates of the design variable value set to be evaluated by means of a data mining technique or Al technique using past cases. For example, a performance value (object variable value) is estimated from candidates of the design variable value set to be evaluated by means of a data mining technique using accumulated past cases (past cases, accumulated past cases). When it is determined that the predicted performance value adequately satisfies an evaluation index, actual evaluation of the candidates are made. On the other hand, when it is determined that the estimated performance value can never satisfy an evaluation index, actual evaluation is not made, and the candidates are discarded.

As a technique relating to the present invention, there is known a predicting apparatus that performs highly accurate prediction at high speed based on similar cases. Further, there is known a case predicting apparatus that generates highly accurate prediction results that adapt to a variety of unknown cases by optimizing distance, similarity, evaluation values or the like according to information obtained from all known cases, during prediction processes based on similar cases. Further, there is known a predicting apparatus with reliability scale that adds a reliability scale indicating the reliability of confidence to be outputted by the predicting apparatus based on a similar case.

### [Patent Document 1] Japanese Laid-open Patent Publication No. 2000-155681

### [Patent Document 2] Japanese Laid-open Patent Publication No. 2003-323601

### [Patent Document 3] Japanese Laid-open Patent Publication No. 2004-206167

The above method for improving efficiency of the evaluation is based on the assumption that an object variable value corresponding to a future design variable value set can be estimated with high accuracy from past cases. However, the past evaluation is not made in consideration of a future design variable value set but is made for only a design variable value set required at that time point. Therefore, in some design variable value set to be evaluated, an estimation error is increased, resulting in an incorrect estimation.

It is desirable to collect cases of various design variable value set in order to solve the above problem. However, there exist a large number of design variable value sets and the large number of design variable value sets interact with an object variable value. Thus, to exhaustively collect the cases is not a realistic solution.

### SUMMARY

According to an aspect of the invention, a computer-readable recording medium stores a case generation program that allows a computer to execute a process of generating a case having one or more design variable values and one or more object variable values corresponding to the design variable values, the process including: acquiring, from a storage section, a plurality of past cases which are obtained through a past evaluation process; predicting the object variable value of the past cases from the design variable values of the acquired past cases; calculating a prediction error and confidence as the prediction result of the past cases; selecting a reference case being a past case used as a reference of the generation based on the calculated prediction error and the confidence; determining a new design variable value based on the design variable value of the selected reference case; and determining a new case based on the new design variable value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a case collection apparatus according to an embodiment of the present invention;

FIG. 2 is a table illustrating a first example of data stored in a past case storage section according to the present embodiment;

FIG. 3 is a flowchart illustrating an example of operation of the case collection apparatus according to the present embodiment;

FIG. 4 is a table illustrating a second example of data stored in the past case storage section according to the present embodiment;

FIG. 5 is a graph illustrating an example of a stable past case and an unstable past case;

FIG. 6 is a graph illustrating an example of the collection point candidates according to the present embodiment;

FIG. 7 is a view illustrating operation of a 5-fold cross-validation method according to the present embodiment;

FIG. 8 is a view illustrating an example of a change probability calculation method;

FIG. 9 is a table illustrating an example of a first influence degree according to the present embodiment; and

FIG. 10 is a table illustrating an example of a second influence degree according to the present embodiment.

### DESCRIPTION OF EMBODIMENT(S)

An embodiment of the present invention will be described below with reference to the accompanying drawings.

First, MBR (Memory-Based Reasoning) used in the present embodiment will be described.

The MRB can predict an object variable value from an explanatory variables (design variables) of an unknown case using known cases (past cases) and calculate a prediction result, confidence of the prediction result, and degree of influence for each design variable.

In a multidimensional space in which each of explanatory variables is represented as a coordinate, an explanatory variable value set of one known case is represented by one point. The MBR searches for k points of known cases close to a point of an unknown case from points of accumulated cases and calculates a prediction value of an object variable value using a weighted sum of the k points of known cases.

The MBR is performed according to the following procedure.

S101) The degree of influence of each of explanatory variable values of known cases on the object variable is calculated.

S102) The similarity of each of known cases with respect to an unknown case is calculated.

S103) The similarity calculated in step S102 is used to select k known cases that are most similar to the unknown case and the selected k known cases are set as similar cases.

S104) A prediction result is calculated from the obtained k similar cases.

S105) The confidence of the obtained prediction result is calculated.

Next, the details of the above steps of the MBR will be described.

First, step S101 will be described. The degree of influence is the strength of influence of each explanatory variable or each explanatory variable value on the object variable value and is calculated from known cases by probability calculation. As the probability calculation, a MIC (Mutual Information Content) method that calculates the degree of influence for each explanatory variable, a CCF (Cross-Category Feature importance) method that calculates the degree of influence for each explanatory variable value, or a newCCF (new Cross-Category Feature importance) method can be used.

In the case of the MIC method, the degree of influence can be calculated according to the following expression.

$${w}_{i} = \frac{{\sum }_{v} {\sum }_{c} p ( v , c ) log \frac{p ( v , c )}{p ( v ) p ( c )}}{- {\sum }_{c} p ( c ) log p ( c )}$$

In the above expression, c denotes object variable values, i denotes the number of an explanatory variable, v denotes the value of the explanatory variable, p(v,c) denotes the joint probability that the explanatory variable assumes v and object variable assumes c, and wᵢ denotes the degree of influence of i-th explanatory variable.

That is, the MIC method calculates the degree of influence of each explanatory variable according to mutual information. In the case where the joint probability of a given explanatory variable with the object variable is largely biased, the given explanatory variable is regarded as an important explanatory variable for prediction, and the degree of influence wᵢ obtained at that time is approximated to 1. On the other hand, in the case where the joint probability of a given explanatory variable with the object variable is biased a little, the given explanatory variable is not regarded as an important explanatory variable for prediction, and the influence degree value w is approximated to 0.

In the case of the CCF method, the degree of influence can be calculated according to the following expression.

$${w}_{i} ( v ) = {\sum }_{c} {p ( c \vert v )}^{2}$$

In the above expression, c denotes object variable values, i denotes the number of an explanatory variable, v denotes the value of the explanatory variable, p(c|v) denotes the probability that the object variable value assumes c when the explanatory variable assumes v, and wᵢ denotes the degree of influence of i-th explanatory variable.

That is, the CCF method squares the probability that the object variable value assumes c when the explanatory variable assumes v and the results are summed up for all classes. Thus, in the case where the object variable necessarily assumes a single value of c when the explanatory variable assumes a given value of v, the degree of influence becomes 1; on the other hand, in the case where the probability that the object variable assumes all values of c when the explanatory variable assumes v is uniform, the degree of influence becomes a minimum value (1/N_{c}) (N_{c} is the number of object variable values).

In the case of the newCCF method, the degree of influence can be calculated according to the following expression.

$${q}_{v} ( c ) = p ( c \vert v ) / p ( c )$$

$${w}_{i} ( v ) = \frac{{\sum }_{c} \vert \frac{{q}_{v} ( c )}{{\sum }_{d} {q}_{v} ( d )} - \frac{1}{{N}_{c}} \vert}{2 - \frac{2}{{N}_{c}}}$$

In the above expression, c denotes object variable values, i denotes the number of an explanatory variable, v denotes the value of the explanatory variable, N_{c} denotes the number of the object variable values, p(c) denotes the probability that the object variable value assumes c, p(c|v) denotes the probability that the object variable value assumes c when the explanatory variable assumes v, and wᵢ denotes the degree of influence of i-th explanatory variable. Further, qᵥ(c) denotes a ratio of the probability that the object variable value assumes c when the explanatory variable assumes v relative to the probability that the object variable value assumes c.

The newCCF method is modified from the CCF method in the following two points.

1) Bias in the distribution of the object variable values is taken into consideration.

2) The degree of influence is made 0 when a given explanatory variable value v does not contribute to determination of the object variable value.

That is, in the newCCF method, a numerator becomes 0 when the distribution of the object variable values c exhibited when the explanatory variable assumes a give value of v coincides with the entire object variable value distribution, so that the degree of influence becomes 0 (minimum value), and thus the influence in the prediction of the explanatory variable value can be eliminated. On the other hand, as in the case of the CCF method, in the case where the object variable assumes only a single value of c when the explanatory variable assumes a given value of v, the degree of influence becomes 1.0.

In any of the MIC method, CCF method, and newCCF method, when there is a missing value in the known cases, the influence degree calculation is performed after the record in which the missing value exists is deleted. Further, in any of the above methods, in the case where the explanatory variable has a numeric attribute, v denotes not a single value but a numeric range.

Next, step S102 will be described. The similarity is a scale of similarity between case data. Similarity S between a given known case and unknown case can be calculated according to the following expression.

$${d}_{i} \{ \begin{matrix}\frac{difference in attribute values}{Standard deviation} & … & ( numerical attribute ) \\ \{ \begin{matrix}0 & ( accordance ) \\ 1 & ( discordance )\end{matrix} & … & ( category value attribute )\end{matrix} \\ S = \frac{1}{\sqrt{{\sum }_{i} {w}_{i} ( v ) \times {( {d}_{i} )}^{2}}}$$

In the above expressions, wᵢ(v) denotes the degree of influence (degree of influence obtained when i-th explanatory variable of unknown cases is v) calculated in step S101, dᵢ denotes the distance between single attributes of the i-th explanatory variable. That is, the similarity means the inverse number of a distance with influence degree between cases, and the more two cases resemble each other, the higher the similarity becomes.

In the case where a missing value is included in known cases, the similarity is calculated with the distance dᵢ between single attributes in the relevant attribute set to 1 and in the case where a missing value is included in the unknown case, the similarity is calculated with the distance dᵢ between single attributes in the relevant attribute set to 0.

Next, step S103 will be described. In step S102, the similarity between each of the known cases and unknown case is calculated, and the similarity calculated in step S102 is used to select k known cases that are most similar to the unknown case and the selected k known cases are set as similar cases. Here, the number k of the similar cases is determined by any of the following methods.

a) Previously specified by a user.

b) Some of the known cases are regarded as unknown cases, prediction operation using a plurality of k-values is repeated, and a k-value having the highest prediction success rate is set as an optimum value. The prediction operation will be described later in step S104.

Next, step S104 will be described in two cases: a case where the object variable is a category value attribute and a case where the object variable is a numerical attribute.

a) A case where the object variable is a category value attribute

Similar cases are used to calculate similarity sum T_{c} for each object variable value according to the following expression.

$${T}_{c} = {\sum }_{{S}_{j} ∈ c} {S}_{j}$$

In the above expression, Sⱼ denotes the similarity between a j-th similar case in the k similar cases selected in step S103 and unknown case.

Then, an object variable value that gives a maximum T_{c} and is obtained from the calculated T_{c}s in each of the object variables is set as prediction value c_{predict}. The c_{predict} is calculated according to the following expression.

c_{predict}=[c|Max(T_{c})]

b) A case where the object variable is a numeric attribute

The prediction value c_{predict} is calculated according to the following expression.

$${c}_{predict} = \frac{{\sum }_{j}^{k} {S}_{j} \cdot {c}_{j}}{{{\sum }_{j}}^{k} {S}_{j}}$$

It is assumed here that the number of similar case data is k, similarity between a j-th similar case and unknown case is Sⱼ, and object variable value of the j-th similar case data is cⱼ. That is, a prediction value is determined using a similarity-based weighted sum.

Next, step S105 will be described. The confidence is a scale denoting the occurrence probability of a prediction result. The description will be made in two cases: a case where the object variable is a category value attribute and a case where the object variable is a numerical attribute.

a) A Case where the Object Variable is a Category Value Attribute

A confidence P can be calculated according to the following expression as a ratio of similarity sum of the prediction values c_{predict} relative to similarity sum of object variable values.

$$P = \frac{{T}_{{c}_{predict}}}{{\sum }_{c} {T}_{c}}$$

b) A Case where the Object Variable is a Numeric Attribute

Similarly, the confidence P can be calculated according to the following expression.

$$P = \frac{1}{\frac{{\sum }_{j}^{k} {S}_{j} \cdot {( {c}_{j} - {c}_{predict} )}^{2}}{{σ}_{c}^{2} \cdot {{\sum }_{j}}^{k} {S}_{j}} + 1}$$

In the above expression, σ_{c} denotes the standard deviation of the object variables.

In the manner as described above, the MBR can present a prediction value of the object variable value of the unknown case and its confidence by using the degree of influence of known cases and the known cases.

In the present embodiment, a case collection apparatus applying the case generation apparatus of the present invention and collecting cases will be described. The accumulated cases and cases collected by the case collection apparatus are used for estimating the object variable value from a design variable value set in the subsequent designing. With this estimation, it can be determined whether there is a need to perform evaluation for the design variable value set to thereby minimize the evaluation (real machine test or computer simulation).

A configuration of the case collection apparatus will be described.

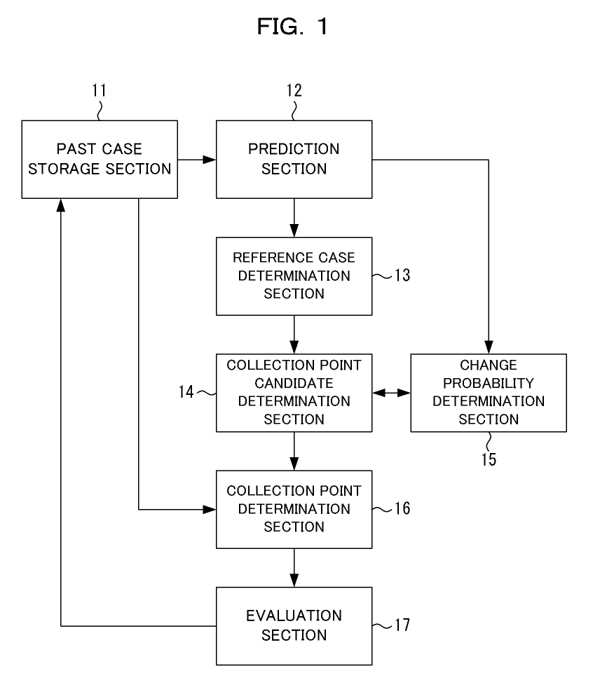

FIG. 1 is a block diagram illustrating an example of a configuration of the case collection apparatus according to the present embodiment. The case collection apparatus includes a past case storage section 11, a prediction section 12, a reference case determination section 13, a collection point candidate determination section 14, a change probability determination section 15, a collection point determination section 16, and an evaluation section 17.

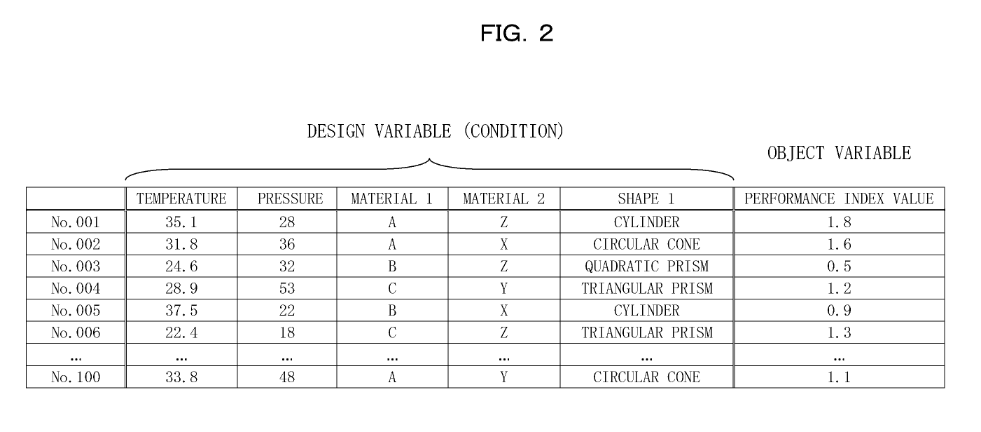

The past case storage section 11 stores past cases. FIG. 2 is a table illustrating a first example of data stored in the past case storage section according to the present embodiment. A large number of past cases obtained through past evaluation are accumulated in the past case storage section 11. One past case is constituted by case number, one or more design variables, and one or more object variables. In the present embodiment, the design variable includes temperature (design variable 1), pressure (design variable 2), material 1 (design variable 3), material 2 (design variable 4), and shape 1 (design variable 5), and the object variable includes performance index value (e.g., vibration at a given time point).

Next, operation of the case collection apparatus according to the present embodiment will be described.

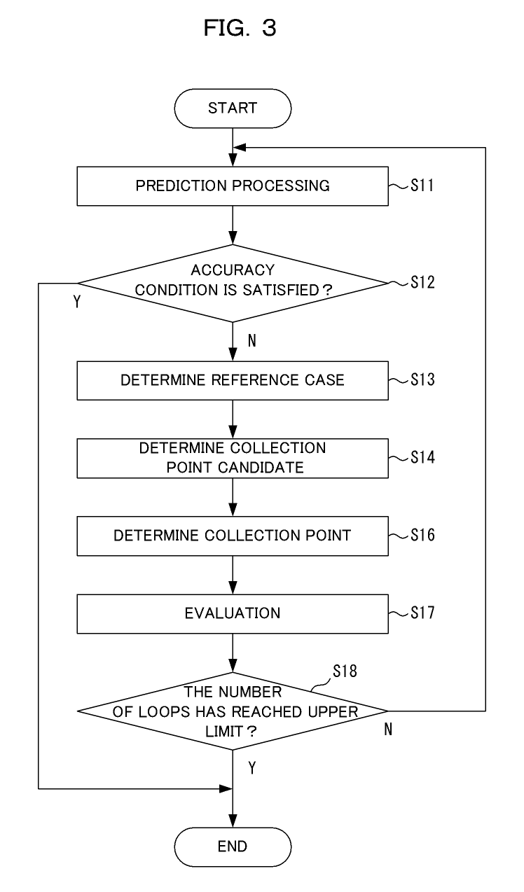

FIG. 3 is a flowchart illustrating an example of operation of the case collection apparatus according to the present embodiment. As a first loop, the prediction section 12 reads out past cases from the past case storage section 11, performs cross-validation using the MBR to thereby calculate a prediction result of the object variable value for each past case and confidence of the prediction result, and performs prediction processing of calculating a prediction error from the object variable value (true value) stored in the past case storage section 11 and object variable value which is a prediction result (S11).

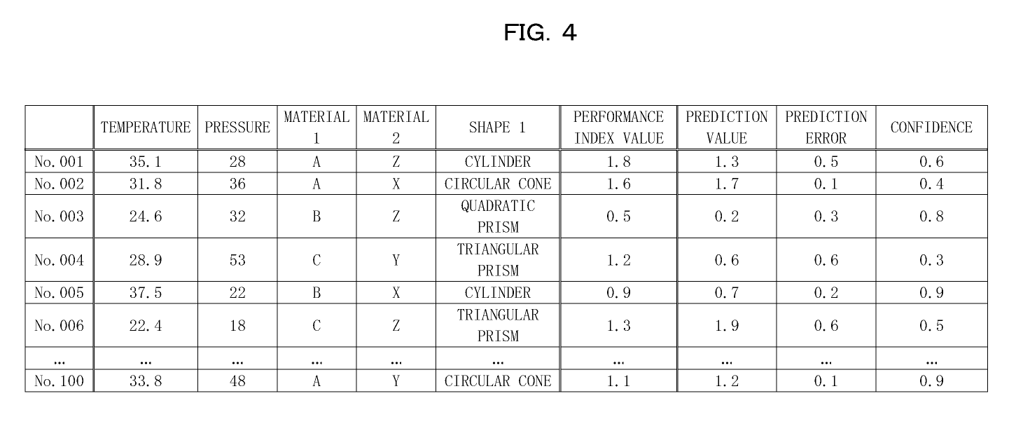

The prediction section 12 adds the calculated prediction result, prediction error, and confidence to the corresponding past case stored in the past case storage section 11. FIG. 4 is a table illustrating a second example of data stored in the past case storage section according to the present embodiment. As illustrated in FIG. 4, the prediction result (prediction value) of the object variable value, prediction error, and confidence are added to the data of FIG. 2.

Then, after the prediction processing, the prediction section 12 determines whether all the past cases satisfy an accuracy condition (S12). The accuracy condition is satisfied when the prediction error of the past case falls within a predetermined allowable error and the confidence of the relevant past case is not less than a preset confidence threshold. The allowable error is e.g., 10%, and confidence threshold is, e.g., 0.8.

When the accuracy condition is satisfied (Yes in S12), this flow is ended. On the other hand, when the accuracy condition is not satisfied (No in S12), the reference case determination section 13 determines a reference case which serves as a reference case for collecting cases from the past cases (S13). The reference case determination section 13 determines, as the reference case, a past case that does not satisfy the above accuracy condition (i.e., past case having a larger prediction error than the allowable error or having a confidence smaller than the confidence threshold). The allowable error used in step S12 and that used in step S13 may differ from each other. Further the confidence threshold used in step S12 and that used in step S13 may differ from each other.

Referring to FIG. 4, past cases (case numbers 001, 003, 004, 005, and 006) each having a prediction error exceeding the allowable error, as well as, a past case (case number 002) having a confidence not larger than the threshold are determined as the reference cases.

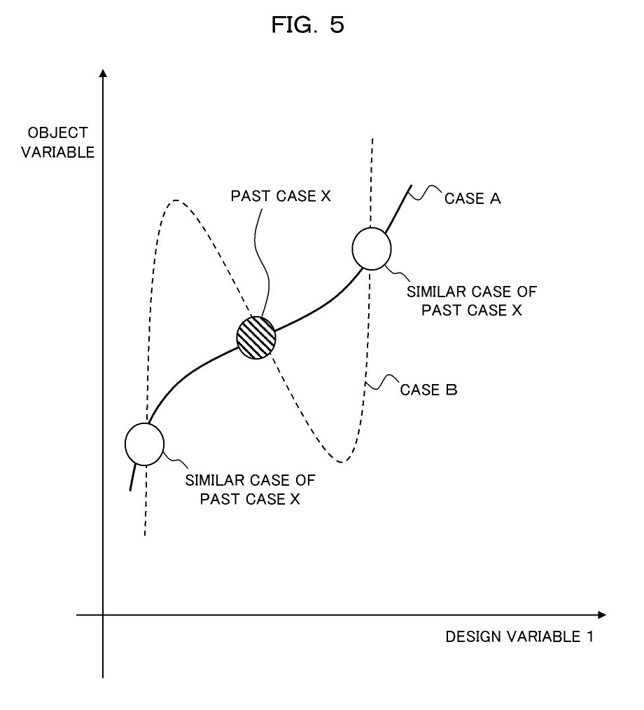

If the reference case is determined only with the prediction error, there may be a potentially unstable location where a variation of the object variable value is large in the vicinity of the determined reference case even if the prediction error falls within the allowable error. FIG. 5 is a graph illustrating an example of a stable past case and an unstable past case. In a multidimensional space in which each of design variables is represented as a coordinate, a design variable value set of a given case is represented by one point. For simplification, the graph of FIG. 5 illustrates two cases (cases A and B) as curves each representing the relationship between a design variable 1 which is one of the design variables and object variable value. Further, the graph of FIG. 5 illustrates a target past case X and its similar cases.

In this graph, the case A has a small variation in the object variable value in the vicinity of the past case X and thus has a large confidence; while the case B has a large variation in the object variable value in the vicinity of the past case X and thus has a small confidence. Therefore, it can be determined that the past case of the case B having a small confidence is unstable point. By determining an unstable past case in consideration of not only the prediction error but also the confidence as the reference case, it is possible to generate a case with an unstable region.

Then, the collection point candidate determination section 14 determines a generation range in the vicinity of a point represented by a design variable value set of the reference case and determines design variable value sets randomly (by random numbers) within the generation range to thereby set the design variable value sets as collection point candidates (S14). More specifically the collection point candidate determination section 14 determines the generation range using an average distance σ (equalized distance in Patent Document 3) between past cases output by the MBR of the prediction section 12. For example, the generation range is set within a superlattice within which each design variable value falls within ±σ with respect to the point of the reference case or within a hypersphere having a diameter of σ with the point of the reference case set as the center thereof. Further the number of the collection point candidates to be generated is previously specified by a user or corresponds to the number k of similar cases output by the MBR of the prediction section 12.

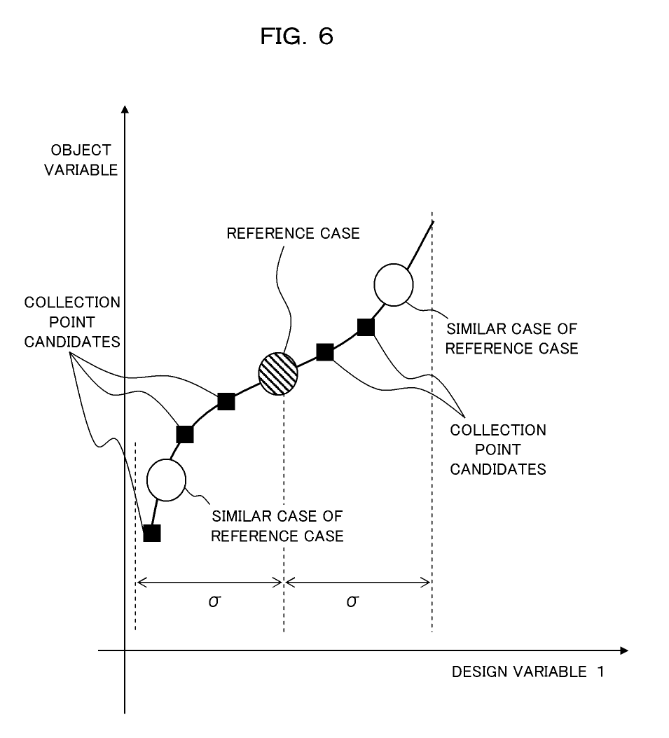

FIG. 6 is a graph illustrating an example of the collection point candidates according to the present embodiment. The graph of FIG. 6 uses a superlattice as the generation range, illustrating a case where k is set to 5, and represents the relationship between the design variable 1 and object variable. In a range where the value of the design variable 1 falls within ±σ from the point of the reference case, values of five design variables 1 are generated by random numbers and are set as the collection point candidates.

The collection point candidate determination section 14 selects one design variable based on the change probability set for each design variable and sets it as a change design variable and randomly changes the value of the change design variable in the reference case within the generation range to thereby generate collection point candidates. The change probability is a probability set for each design variable. A design variable for which the change probability is set is selected by the collection point candidate determination section 14 as the change design variable. The change probability determination section 15 calculates the change probability of each design variable through change probability calculation processing so as to preferentially select a design variable that gives a large influence on the prediction. The change probability determination section 15 may be omitted. In this case, the change probabilities of the design variables are made equal to one another.

Then, the collection point determination section 16 determines a collection point from among the collection point candidates (S16). More specifically the collection point determination section 16 selects a past case that is most similar to each collection point candidate as a most similar case to candidate and determines, based on the reference case and most similar case to candidate, whether each of the collection point candidates satisfies a preset design variable value condition. When a target collection point candidate does not satisfy the design variable value condition, the collection point determination section 16 determines that the case of the collection point candidate need not be collected since there are any other past cases sufficiently similar to the target collection point candidate and discards the collection point candidate. On the other hand, when a target collection point candidate satisfies the design variable value condition, the collection point determination section 16 determines that the case of the collection point candidate needs to be collected since there is no other past case sufficiently similar to the target collection point candidate and determines the collection point candidate as the collection point.

Here, the collection point determination section 16 uses the similar MBR as that used by the prediction section 12 to select, from among the similar cases of the collection point candidates output by the MBR, a similar case the distance between which and the collection point candidate is smallest and sets the selected similar case as a most similar case to candidate. In the design variable value condition, a collection point candidate that satisfies, e.g., the following expression is defined as the collection point.

D (most similar case to candidate)/D (reference case)>ε

In the above expression, D (x) denotes the distance between a target collection point candidate and case x. Therefore, D (most similar case to candidate) denotes the distance between the target collection candidate and most similar case to candidate, and D (reference case) denotes the distance between the target collection point candidate and point of the reference case. ε is e.g., 1.

Then, the evaluation section 17 performs evaluation for the design variable value set which is the collection point determined by the collection point determination section 16 to acquire the object variable value and records, as a past case, the design variable value set and object variable value in the past case storage section 11 (S17). Then, the prediction section 12 determines whether the number of loops has reached a predetermined upper limit (S18). In the case where the number of loops has not reached the upper limit (No in S18), the flow shifts to step S11. In the case where the number of loops has reached the upper limit (Yes in S18), this flow is ended.

Next, details of the prediction processing will be described.

A cross-validation in the prediction processing is a method that uses past cases whose results are known to quantitatively evaluate the prediction accuracy.

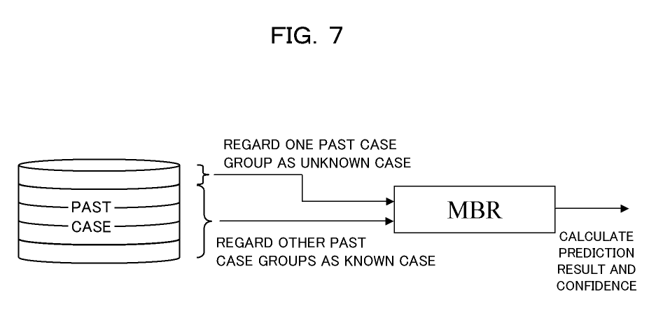

In the present embodiment, a 5-fold cross-validation method is used. FIG. 7 is a view illustrating operation of the 5-fold cross-validation method according to the present embodiment. The prediction section 12 divides all the past cases stored in the past case storage section 11 into 5 groups and selects one group from the five groups as a target group. Then, the prediction section 12 predicts the object variable value of the target group based on the remaining 4 groups by the MBR while concealing the object variable value of the target group. Then, the prediction section 12 performs the prediction for all the past cases while changing the target group. Then, the prediction section 12 compares the predicted object variable values and actual object variable values (true values) of the past cases to calculate a prediction error. In the case where the number of cases is small, a leave-one-out cross-validation method in which the number of divides is set as the number of cases is used for preventing a variation caused due to the division.

Next, details of the change probability calculation processing will be described.

As the change probability calculation processing, there are available the following two methods.

(Method 1) The change probability is calculated based on the point of the reference case and point of a most similar case to reference case which is a past case the distance between which and reference case is smallest in the relationship between each of the design variable and object variable.

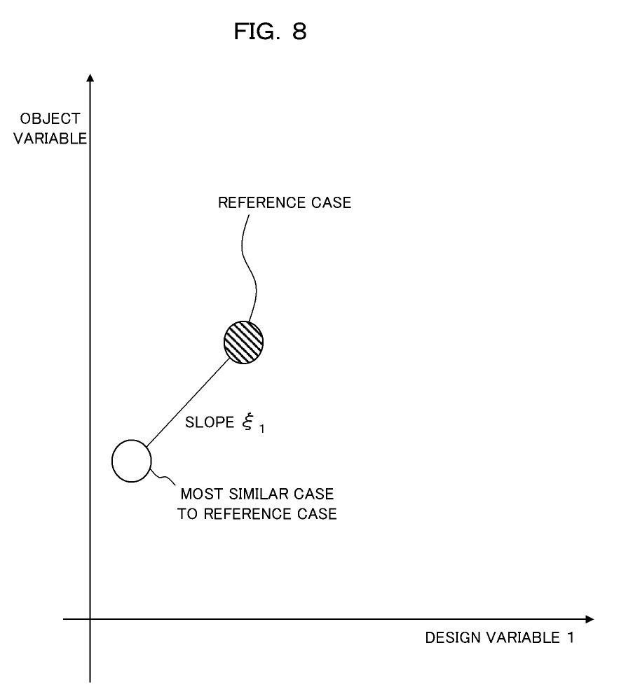

FIG. 8 is a view illustrating an example of the change probability calculation method. Assuming that one object variable exists for N design variables (design variables 1 to N), a curve of FIG. 8 represents the relationship between the design variable 1 of the N design variables and object variable and straight line of FIG. 8 connects the point of the reference case and point of most similar case to reference case in the relationship between the design variable 1 and object variable. The slope of the straight line is assumed to be ξ₁. The change probability of the design variable 1 is represented as ξ₁/Σξᵢ. σξᵢ is the sum of the slopes of N design variables. That is, the change probability is calculated for each design variable, and whether the value of the design variable is changed or not is then determined.

(Method 2) Data is changed with the degree of influence for each design variable set as the change probability.

The degree of influence calculated by the MBR may be a first influence degree in which one influence degree value is set for one design variable or a second influence degree in which the influence degree value for one design variable changes depending on the design variable value.

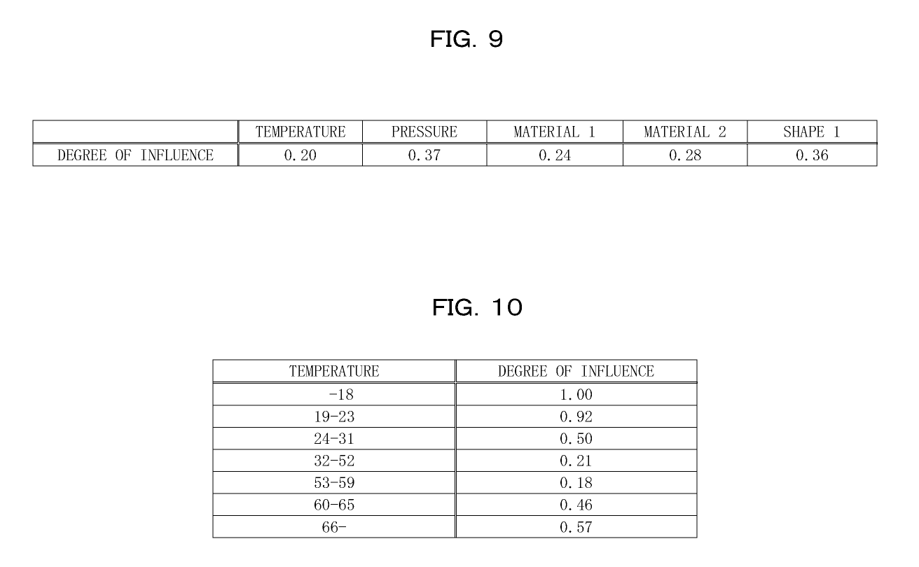

The first influence degree will be described. FIG. 9 is a table illustrating an example of the first influence degree according to the present embodiment. The design variable here includes temperature, pressure, material 1, material 2, and shape 1, and one influence degree is calculated for each of them. The degree of influence in this case is an expected value of the influence degree by a MIC method, CCF method, or newCCF method. Assuming that the influence degree of the design variable 1 is ω₁, the change probability of the design variable 1 is calculated according to the following expression: ω₁/Σω₁. Here, Σω₁ is the sum of the influence degree of all the design variables. That is, whether the value of the design variable is changed or not is determined according to the change probability of for each design variable.

The second influence degree will be described. FIG. 10 is a table illustrating an example of the second influence degree according to the present embodiment. Seven range values are set for temperature which is one of the design variables, and the degree of influence is calculated for each range. In this case, by setting the influence degree corresponding to the value of the design variable 1 at the point of the reference case to ω₁, the change probability can be calculated in the same manner as the first influence degree.

According to the operation of the case collection apparatus, a past case having a larger prediction error or having a smaller confidence is set as the reference case, and the slope of the object variable with respect to the design variable value or MBR influence degree is utilized. In this way, the design variable value of the case can effectively be generated. Further, by taking not only the prediction error but also the confidence into consideration, it is possible to find a potentially unstable location (in the vicinity of the point of the past case) so as to set the location as the reference case of the case to be collected. Further, by controlling the change probability for each design variable by using the slope or MBR influence degree, it is possible to effectively acquire only a meaningful case, thus preventing cases from being uselessly and exhaustively generated.

As described above, according to the present embodiment, in the case where various design variable value and object variable values need to be accumulated for effective evaluation, it is possible to effectively acquire the cases without exhaustively acquiring a large number of sets of the design variable values.

An acquisition section corresponds to the past case storage section 11 of the embodiment. A prediction section corresponds to the prediction section 12 of the embodiment. A selection section corresponds to the reference case determination section 13 of the embodiment. A determination section corresponds to the collection point candidate determination section 14, change probability determination section 15, collection point determination section 16, and evaluation section 17 of the embodiment. An acquisition step corresponds to the acquisition of past cases from the past case storage section 11 in the embodiment. A prediction step corresponds to step S11 in the embodiment. A selection step corresponds to step S13 in the embodiment. A determination step corresponds to steps S14, S16, and S17 in the embodiment.

Further, it is possible to provide a program that allows a computer constituting the case generation apparatus to execute the above steps as a case generation program. By storing the above program in a computer-readable recording medium, it is possible to allow a CPU of the computer constituting the case generation apparatus to execute the program. The computer-readable recording medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; and another computer and database thereof.

According to the present embodiment, it is possible to effectively generate a case enabling highly accurate prediction.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium storing a case generation program that allows a computer to execute a process of generating a case having one or more design variable values and one or more object variable values corresponding to the design variable values, the process comprising:
acquiring, from a storage section, a plurality of past cases which are obtained through a past evaluation process;
predicting the object variable value of the past cases from the design variable values of the acquired past cases;
calculating a prediction error and confidence as the prediction result of the past cases;
selecting a reference case being a past case used as a reference of the generation based on the calculated prediction error and the confidence;
determining a new design variable value based on the design variable value of the selected reference case; and
determining a new case based on the new design variable value.

2. The computer-readable recording medium according to claim 1, wherein
the calculating calculates the prediction error and confidence for each past case by a cross-validation using a MBR (Memory-Based Reasoning).

3. The computer-readable recording medium according to claim 1, wherein
the determining of the design variable value determines a range of the new design variable value based on the design variable value of the reference case selected by the selecting, randomly generates candidates of the new design variable values within the determined range, and determines one of the candidates that satisfies a predetermined design variable value condition as the new design variable value.

4. The computer-readable recording medium according to claim 1, wherein
the determining of the case further performs evaluation for the new design variable value and adds, as a past case, the design variable value and object variable value obtained by the evaluation of the design variable value.

5. The computer-readable recording medium according to claim 4, wherein
the predicting, the calculating, the selecting, the determining of the design variable value, and the determining of the case are repeated until a predetermined end condition is satisfied.

6. The computer-readable recording medium according to claim 5, wherein
the end condition is that the prediction results of all the past cases calculated by the calculating satisfy a predetermined accuracy condition or that the predicting, the calculating, the selecting, the determining of the design variable value, and the determining of the case are repeated by a predetermined number of times.

7. The computer-readable recording medium according to claim 6, wherein
the accuracy condition is satisfied when the prediction error of the past case is not more than a predetermined prediction error threshold and the confidence of the relevant past case is not less than a predetermined confidence threshold.

8. The computer-readable recording medium according to claim 1, wherein
the selecting selects the past case as the reference case when the prediction result of the past case calculated by the calculating does not satisfy a predetermined accuracy condition.

9. The computer-readable recording medium according to claim 8, wherein
the accuracy condition is satisfied when the prediction error of the past case is not more than a predetermined prediction error threshold and the confidence of the relevant past case is not less than a predetermined confidence threshold.

10. The computer-readable recording medium according to claim 3, wherein
the determining of the design variable value selects a most similar case to candidate which is a case most similar to the candidate from among the past cases by using the MBR, calculating a most similar case distance which is the distance between the candidate and most similar case to candidate and a reference case distance which is the distance between the candidate and reference case used as the reference of the candidate, and
the design variable value condition is a condition of the most similar case distance and reference case distance.

11. The computer-readable recording medium according to claim 3, wherein
the calculating further calculates an average distance between the past cases, and
the determining of the design variable value sets a range where the distance from the design variable value of the reference case is not more than the average distance as a range of the new design variable value.

12. The computer-readable recording medium according to claim 3, wherein
the calculating calculates the number of similar cases by the MBR, and
the determining of the design variable value generates design variable values by the number corresponding to the number of the similar cases in the range of the new design variable value.

13. The computer-readable recording medium according to claim 1, wherein
the determining of the design variable value determines the change probability which is the probability of changing the design variable for each design variable, determines the design variable to be changed based on the change probability, and determines the new design variable value by changing the design variable value in the reference case.

14. The computer-readable recording medium according to claim 13, wherein
the determining of the design variable value selects, from among the past cases, a most similar case to reference case which is a past case the distance between which and the reference case is smallest and determines the change probability based on the reference case and most similar case to reference case.

15. The computer-readable recording medium according to claim 13, wherein
the calculating further calculates the degree of influence for each design variable by the MBR, and
the determining of the design variable value determines the change probability based on the degree of influence for each design variable.

16. A case generation apparatus that generates a case having one or more design variable values and one or more object variable values corresponding to the design variable values, the apparatus comprising:
an acquisition section that acquires, from a storage section, a plurality of past cases which are obtained through a past evaluation process;
a prediction section that predicts the object variable value of the past cases from the design variable values of the past cases acquired by the acquisition section and calculates a prediction error and confidence as the prediction result of the past cases;
a selection section that selects a reference case being a past case used as a reference of the generation based on the prediction error and the confidence calculated by the prediction section;
a determination section that determines a new design variable value based on the design variable value of the reference case selected by the selection section and determines a new case based on the new design variable value.

17. The case generation apparatus according to claim 16, wherein
the prediction section calculates the prediction error and confidence for each past case by a cross-validation using a MBR (Memory-Based Reasoning).

18. The case generation apparatus according to claim 16, wherein
the determination section further performs evaluation for the new design variable value and adds, as a past case, the design variable value and object variable value obtained by the evaluation of the design variable value.

19. The case generation apparatus according to claim 18, wherein
the prediction section, selection section, and determination section repeat their processing until a predetermined end condition is satisfied.

20. A case generation method that generates a case having one or more design variable values and one or more object variable values corresponding to the design variable values, the method comprising:
acquiring, from a storage section, a plurality of past cases which are obtained through a past evaluation process;
predicting the object variable value of the past cases from the design variable values of the acquired past cases;
calculating a prediction error and confidence as the prediction result of the past cases;
selecting a reference case being a past case used as a reference of the generation based on the calculated prediction error and the calculated confidence;
determining a new design variable value based on the design variable value of the selected reference case; and
determining a new case based on the new design variable value.
